(19) United States
(12) Patent Application Publication
(10) Pub. No.: US 2025/0131438 A1
(43) Pub. Date: Apr. 24, 2025

(54) SYSTEMS AND METHODS TO DETECT FRAUD AND GRANT LIABILITY SHIFT

(71) Applicant: Capital One Services, LLC, McLean, VA (US)

(72) Inventors: Madeline RIESE, McLean, VA (US); Matthew KLOSTER, Falls Church, VA (US); Jeffrey RULE, Chevy Chase, MD (US)

(73) Assignee: Capital One Services, LLC, McLean, VA (US)

(21) Appl. No.: 18/915,845

(22) Filed: Oct. 15, 2024

Related U.S. Application Data
(60) Provisional application No. 63/544,928, filed on Oct. 19, 2023.

(51) Int. Cl. G06Q 20/40

(52) U.S. Cl. CPC G06Q 20/4016

(57) ABSTRACT

An exemplary method for collaborative fraud prevention comprises receiving, by a processor, merchant data pertaining to a user, receiving, by the processor, issuer data pertaining to the user, receiving, by the processor, third party metrics data pertaining to the user, and receiving, by the processor, mobile device data for a mobile device associated with the user. The exemplary method further comprises applying, by the processor, a machine learning model to the merchant data, issuer data, third-party metrics, and mobile device data to make a fraud prediction, receiving, by the processor, feedback on the fraud prediction, and updating, by the processor, the machine learning model using the feedback as an input.

### CROSS-REFERENCE TO RELATED APPLICATION

This application claims the priority of U.S. Provisional Patent Application No. 63/544,928, filed Oct. 19, 2023, the contents of which are incorporated herein by reference in their entirety.

### FIELD OF THE DISCLOSURE

The present disclosure relates to systems and methods for sharing data between a merchant and an issuer to detect fraud and grant liability shift from the merchant to the issuer.

### BACKGROUND

Credit card and transaction-based fraud is a common struggle facing consumers, merchants, and account issuers. Systems and measures to combat this type of fraud have been instituted over the years. While these measures are helpful, they are underinclusive and also, fraudulent actors have continued to evolve, adapt, and become ever more savvy. As a result, transaction-based fraud continues today at a strong pace, perhaps fueled in-part by the large shift in consumer shopping preferences from brick-and-mortar stores to online shopping.

When a credit card is offered as payment for goods or services in a transaction, the merchant transmits the credit card data for authorization to a payment processor. The card information is routed through a card network and eventually ends at the card issuing bank for approval. The issuing bank will approve or deny the transaction. If the bank denies the transaction, it is usually based on one of a number of different reasons such as a card verification value (CVV) or card number mismatch, an expired card, a closed account associated with the card, insufficient funds, etc.

Even if card issuers and/or banks wanted to implement more robust fraud prevention methods and systems, they have very limited information on which to make a potential fraud determination. Of course, when trying to determine if a pending transaction is fraudulent, having access to information about the transaction request is key. However, issuers only have very limited information about a pending transaction, such as date, transaction amount, merchant, card details, etc. It would be beneficial to have additional information about the transaction and the consumer in order to make a more accurate fraud prediction.

Merchants, on the other hand, often have access to much more relevant information about a pending purchase as well as the consumer, including purchase history, items being purchased, item costs, as well as other user-based information. Merchants, however, may not explicitly collect this information and do not share the information with issuers. Thus, issuers are left making fraud decisions on limited datasets.

These and other deficiencies exist. Accordingly, there is a need for creating issuer access to additional relevant transaction data, especially from merchants.

### SUMMARY OF THE DISCLOSURE

In some aspects, the techniques described herein relate to a method for collaborative fraud prevention, the method including the steps of: receiving, by a processor, merchant data pertaining to a user; receiving, by the processor, issuer data pertaining to the user; receiving, by the processor, third party metrics data pertaining to the user; receiving, by the processor, mobile device data for a mobile device associated with the user; applying, by the processor, a machine learning model to the merchant data, issuer data, third-party metrics, and mobile device data to make a fraud prediction; receiving, by the processor, feedback on the fraud prediction; and updating, by the processor, the machine learning model using the feedback as an input.

In some aspects, the techniques described herein relate to a method, wherein the merchant data is based on a transaction request initiated by the user.

In some aspects, the techniques described herein relate to a method, wherein the merchant data includes the user device data.

In some aspects, the techniques described herein relate to a method, wherein the processor sends a request for one or both of the mobile device data and the third party metrics data.

In some aspects, the techniques described herein relate to a method, wherein the transaction request is approved or denied based on the fraud prediction.

In some aspects, the techniques described herein relate to a method, wherein a user authentication requirement is stepped up based on the fraud prediction.

In some aspects, the techniques described herein relate to a method, further including, sending, via the processor, a fraud notification to the mobile device associated with the user.

In some aspects, the techniques described herein relate to a method, wherein upon fraud at a merchant reaching a threshold level, an issuer associated with the processor accepts liability for fraudulent transactions at the merchant.

In some aspects, the techniques described herein relate to a method, further including, receiving, via a communication hub, supplemental user data from a plurality of issuers or a plurality of banks.

In some aspects, the techniques described herein relate to a method, further including, sending, via the processor, the fraud prediction to the communication hub.

In some aspects, the techniques described herein relate to a system for collaborative fraud prevention, the system including: a memory storing issuer data for a user; and a processor configured to: receive merchant data pertaining to a user; receive the issuer data for the; receive third party metrics data pertaining to the user; receive mobile device data for a mobile device associated with the user; apply a machine learning model to the merchant data, issuer data, third-party metrics, and mobile device data to make a fraud prediction; receive feedback on the fraud prediction; and update the machine learning model using the feedback as an input.

In some aspects, the techniques described herein relate to a system, wherein the device data includes a plurality of an internet protocol address, a geo-location, and a unique device ID.

In some aspects, the techniques described herein relate to a system, wherein the merchant data includes a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

In some aspects, the techniques described herein relate to a system, wherein the merchant data includes a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

In some aspects, the techniques described herein relate to a system, wherein the merchant data is based on a transaction request initiated by the user.

In some aspects, the techniques described herein relate to a system, wherein the merchant data includes the user device data.

In some aspects, the techniques described herein relate to a system, wherein the transaction request is approved or denied based on the fraud prediction.

In some aspects, the techniques described herein relate to a system, wherein a user authentication requirement is stepped up based on the fraud prediction.

In some aspects, the techniques described herein relate to a system, wherein upon fraud at a merchant reaching a threshold level, an issuer associated with the processor accepts liability for fraudulent transactions at the merchant.

In some aspects, the techniques described herein relate to a computer-readable non-transitory medium including computer-executable instructions that, when executed by at least one processor, perform procedures including the steps of: receiving, by a processor, merchant data pertaining to a user; receiving, by the processor, issuer data pertaining to the user; receiving, by the processor, third party metrics data pertaining to the user; receiving, by the processor, mobile device data for a mobile device associated with the user; applying, by the processor, a machine learning model to the merchant data, issuer data, third-party metrics, and mobile device data to make a fraud prediction; receiving, by the processor, feedback on the fraud prediction; and updating, by the processor, the machine learning model using the feedback as an input.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a system for sharing data between a merchant and an issuer to detect and prevent fraud as well as shift liability from the merchant to the issuer according to an exemplary embodiment.

FIG. 2 illustrates a sequence of operations for sharing user data during an attempted transaction to detect fraud according to an exemplary embodiment.

FIG. 3 illustrates a sequence of operations for sharing user data during an attempted transaction to detect fraud according to an exemplary embodiment.

FIG. 4 illustrates a sequence of operations for sharing user data during an attempted transaction to detect fraud according to an exemplary embodiment.

FIG. 5 illustrates a system for using a central processor to share data between merchants and issuers to detect and prevent fraud as well as shift liability from a merchant to an issuer according to an exemplary embodiment.

FIG. 6 illustrates a sequence of operations for shifting liability for fraud from a merchant to an issuer according to an exemplary embodiment.

FIG. 7 is a schematic representation of an issuer backend according to an exemplary embodiment.

FIG. 8 is a schematic representation of a machine learning algorithm module within the issuer backend according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

The present invention provides systems and methods by which issuers may shift liability to consumer transaction fraud from merchants to issuers. Currently merchants bear the ultimate burden of fraudulent transactions. Consumers are generally not held liable for fraud on a consumer credit card account, and issuers push the liability onto the merchants. Issuers, however, may be comfortable with accepting the fraud risk if detection systems are sufficiently robust so as to reduce instances of transaction fraud to acceptable levels. A fundamental requirement of creating a robust fraud detection and prevention system is having enough relevant data to make an informed decision. Interestingly, merchants, who bear the burden of transaction fraud, have access to a large amount of relevant data that might be used to prevent such fraud. However, this data is not necessarily collected, and not shared with issuers-who make the fraud determination.

The present invention creates a method and system for merchants to collect and share relevant transaction and user-based data with issuers, thereby allowing for more accurate fraud predicting. The present invention incentivizes merchants to collect and share this data by issuers shifting liability for transaction fraud onto the issuers once instances of fraud are reduced to some defined level.

Further, the present invention employs a machine learning algorithm to analyze and relate the merchant data with issuer data, as well as any other data available to an issuer. The machine learning algorithm predicts the likelihood of fraud based on all of the available data and also may provide the rationale for the prediction. Use of a machine learning algorithm to predict fraud may reduce demands on traditional computer systems used for card authorization (e.g. credit card networks). Additionally, the machine learning algorithm may promote system efficiency by reducing the demands on backend systems over time to improve the functioning of computers and conserve system resources when dealing with large volumes of transaction data.

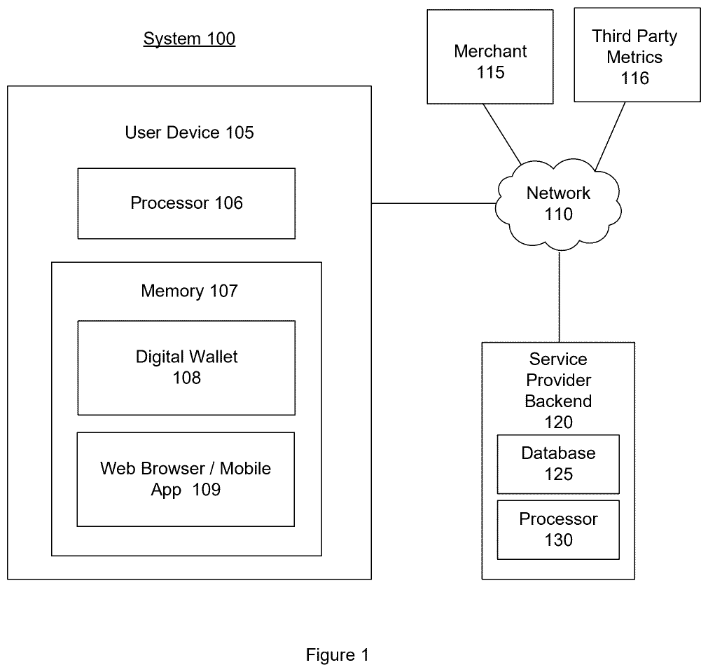

FIG. 1 illustrates a system 100 for using merchant data shared with an issuer to make fraud determinations in attempted merchant transactions. The system 100 may include a user device 105, a network 110, a service provider backend 120, a merchant 115, and third party metrics 116. Although FIG. 1 illustrates single instances of components of system 100, system 100 may include any number of components.

System 100 may include a user device 105. The user device 105 may include one or more processors 106 and memory 107. Memory 107 may include one or more applications, such as web browser and/or mobile app 109 as well as digital wallet 108. Web browser and/or mobile app 109 may be capable of displaying a merchant webpage. The user device 105 may be in data communication with any number of components of system 100. For example, the user device 105 may transmit data via network 110 to merchant 115, which may comprise of browsing a merchant website and/or attempting a purchase transaction from merchant 115. Merchant 115 may be any consumer-based entity and the merchant website may be any website that facilitates transactions for goods and/or services. User device 105 may also transmit data via network 110 to processor 130 and/or database 125 of service provider backend 120. Without limitation, the user device 105 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. The device 105 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 105 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The device 105 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include a network 110. In some examples, network 110 may be one or more of a wireless networks, a wired network or any combination of wireless network and wired network, and may be configured to connect to any one of components of system 100. For example, the device 105 may be configured to connect to service provider backend 120 via network 110. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, near field communication (NFC), Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may include service provider backend 120 which may comprise one or more servers or other computing devices. In some examples, the one or more servers may include one or more processors, represented as processor 130 and coupled to memory, represented as database 125. The server(s) may be configured as a central system, server or platform to control and call various data at different times to execute a plurality of workflow actions.

In some examples, the server(s) can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server, it is understood that other embodiments can use multiple servers or multiple computer systems as necessary or desired to support the users and can also use back-up or redundant servers to prevent network downtime in the event of a failure of a particular server.

The server may include an application in memory comprising instructions for execution thereon. For example, the application may comprise instructions for execution on the server. The application may be in communication with any components of system 100. For example, the server may execute one or more applications that enable, for example, network and/or data communications with one or more components of system 100 and transmit and/or receive data. Without limitation, the server may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server may include processing circuitry and may contain additional components, including processors, memories, error and parity/CRC checkers, data encoders, anticollision algorithms, controllers, command decoders, security primitives and tamper-proofing hardware, as necessary to perform the functions described herein. The server may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

System 100 may include one or more third-party metrics 116. Third party metrics 116 may include any third-party that provides or otherwise makes available data and statistics regarding potential fraud

System 100 may include one or more databases 125. The database 125 may comprise a relational database, a non-relational database, or other database implementations, and any combination thereof, including a plurality of relational databases and non-relational databases. In some examples, the database 125 may comprise a desktop database, a mobile database, or an in-memory database. Further, the database 125 may be hosted internally by any component of system 100 or the database 125 may be hosted externally to any component of the system 100 by a cloud-based platform, or in any storage device that is in data communication with the device 105 and backend 120. In some examples, database 125 may be in data communication with any number of components of system 100. For example, the processor 106 in data communication with the digital wallet 108 may be configured to transmit one or more requests for the requested data from database 125 via network 110.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer and/or processor that can include, for example one or more microprocessors, and use instructions stored on a computer-accessible medium (e.g., RAM, ROM, hard drive, or other storage device). For example, a computer-accessible medium can be part of the memory of the user device 105, service provider backend 120, and/or database 125, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

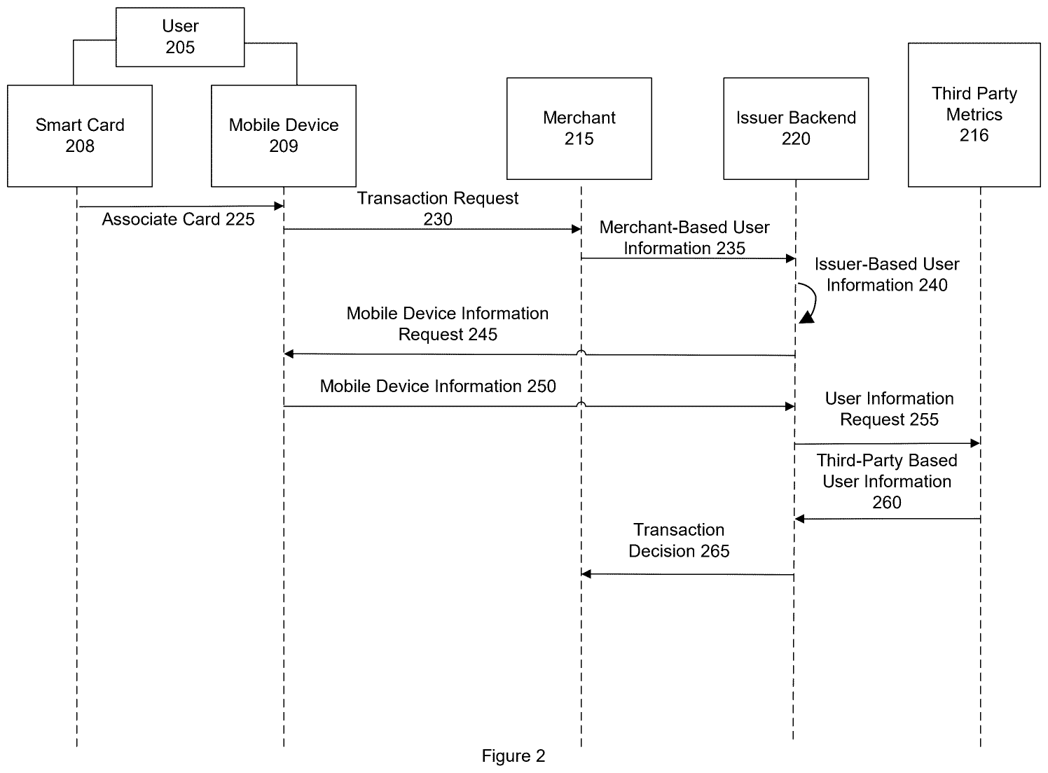

The sequence diagram of FIG. 2 illustrates an exemplary application of embodiments of the invention in conjunction with the system 100 of FIG. 1. In the scenario set forth in FIG. 2, a user 205 has a smart card 208 and a mobile device 209. The mobile device 209 is in communication with a merchant 215 and in some embodiments, an issuer backend 220. Mobile device 209 may be a personal computer, smart phone, smart watch, or any other network enabled computing device. Mobile device 209 may include memory, a network communication, an interactive user interface, and a processor capable of running one or more software applications and a digital wallet. Smart card 208 may be any chip enabled credit card or the like. Smart card 208 may be in communication with mobile device 209 via Bluetooth, NFC, or any other suitable short range communication protocol.

Issuer backend 220 may include one or more processors and may be in communication with mobile device 209, merchant 215, and third-party metrics 216. Backend 220 may be configured to transmit to and receive data from merchant 215 pertaining to a purchase transaction, and may be configured to transmit to and receive data from third party metrics 216.

Merchant 215 may include one or more processors and memory, as well as storage. It may be configured to run one or more websites, apps, etc. It may be further configured to provide a consumer facing sales interface that enables consumer purchase transactions of one or more goods or services on a website or app associated with merchant 215. It may be configured to communicate with backend 220 in order to transmit transaction requests as well as share consumer data.

Third party metrics 216 may include one or more processors and storage, such as a database or databases. It may be configured to receive data requests from issuer backend 220 and respond by providing data responsive to those requests.

User 205 may hold smart card 208 that may be associated with an issuer as well as one or more financial and/or credit accounts, etc. with that issuer. User 205 may also have a mobile device 209. At 225, User 205 may associate smart card 208 with mobile device 209 through any means available. By way of non-limiting example, this may be through inclusion of smart card 208 in a digital wallet of mobile device 209. It may also be through inclusion of smart card 208 with an application installed and running on mobile device 209. The application may be a shopping application or some other application that allows or facilitates payment of online purchases. Smart card 208 may be associated with mobile device 209 through any technological means, including but not limited to, manual entry, NFC, Bluetooth, etc. The association of smart card 208 may permit and/or enable mobile device 209 to collect and/or store information pertaining to user 205 as well as the user's account(s) associated with smart card 208.

At 230, mobile device 209 may transmit a transaction request to merchant 215. User 205 may shop for goods on mobile device 209. The shopping may be directly connected to merchant 215. For example, the shopping may take place on a website hosted by merchant 215 or an app developed and/or supported/hosted by merchant 215. Shopping on mobile device 209 may include adding one or more products to a virtual cart and then virtually checking out with those one or more products. The act of checking out with one or more products may result in mobile device 209 transmitting a transaction request to merchant 215 at step 230.

Merchant 215 may, as a result of receiving transaction request 230, provide merchant-based user information to issuer backend 220 at step 235. In order to provide the merchant-based user information, merchant 215 may collect data relevant to the transaction request. For example, merchant 215 may capture the specifics of the transaction request including number of products, price of products, highest priced item, descriptions of products, time of transaction request, name of user 205, shipping method, phone number, email address, address of user 205, shipping address of user 205, as well as any additional information provided by user 205 in connection with transaction request 230.

Merchant 215 may also include a memory, such as one or more databases, that stores data relevant to user 205. For instance, merchant 215 may store, and have access to, data pertaining to user 205's purchase history, including items and/or services purchased, dates of purchase, transaction amounts, transaction frequency, item purchase repetition, changes in user 205 purchase behavior, whether the transaction request involves a gift card, if the transaction request is a recurring order, age of any user account with merchant 215, velocity metrics (e.g. how often are transactions being requested by user 205 over a given period of time), merchant trust scores for user 205, etc.

Merchant 215 may also collect data from mobile device 209. This data may include one or more internet protocol (IP) addresses, geo-location, one or more unique identifiers (IDs) assigned to the device, etc.

Merchant 215 may package this information and send it to issuer backend 220 in real-time as the transaction request is pending. Historically, merchant 215 does not share any data pertaining to user 205 with an issuer except that data required to process a form of payment offered by user 205. Also historically, a user does not share the risk of fraudulent use of that user's card by a bad actor. The issuer generally alerts the user to the fraud, or the user detects the fraud and alerts the issuer, and then the issuer removes the fraudulent charge(s) from the user's account. The issuer does not bear the burden of loss from the fraudulent use of a user's card. Instead, the traditional approach dictates that the issuer passes that loss onto the merchant. Thus, while merchants have not historically shared user data with issuers, merchant 215 may be incentivized to do so, and to work collaboratively with the issuer if the issuer is willing to ultimately shift the burden of loss from merchant 215 to the issuer associated with issuer backend 220.

The merchant-based user information shared with issuer backend 220 at step 235 may be transmitted off network rails. For example, the merchant-based user information may be sent separate from a credit card network transmission. In some embodiments, the transmission of merchant-based user information may occur in parallel to traditional credit card network transmission seeking to authorize a transaction request.

At step 240, issuer backend 220 may collect issuer-based user information. This data may exist on one or more databases associated with the issuer and in connection with issuer backend 220. The issuer-based user information may include data that the issuer has been able to collect about user 205. For example, issuer-based user information may include user transaction history, not just with merchant 215, but for all purchases made by user 205 with smart card 208 or mobile device 209 (used as proxy for smart card 208 through a digital wallet or the like). This data may also include transaction history for one or more other different accounts held by user 205 with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that user 205 has never used smart card 208 at merchant 215 prior to transaction request 230. Or, this data could reveal that smart card 208 has only ever been used with a single merchant and that merchant is not 215. The information may further reveal that while user 205 has never used smart card 208 with merchant 215, that user has used a different card with merchant 215 on a regular basis. These are relevant pieces of information for issuer backend 220. Another example of relevant issuer-based user information might be a revelation that a large percentage of user purchases occur within a geographic space defined by some measurement. If transaction request 230 originates from a large distance away from that defined geographic location, then this fact could implicate potential fraud. However, if the user's most recent transaction history indicates that user 205 may have travelled to the location where transaction request 230 originates, then that information would mitigate against potential fraudulent activity.

At step 245, issuer backend 220 may request mobile device information from mobile device 209. At step 250, mobile device 209 may return the respond to the request. The response may include one or more pieces of mobile device data. This data may include one or more internet protocol (IP) addresses, geo-location, one or more unique ID's assigned to the device, etc. This information request may be instead of the merchant collecting and providing this information to issuer backend 220 at step 235. Alternatively, this request may be in addition to the device information sent at step 235 and may serve to confirm the device information. In some embodiments, a digital wallet where smart card 208 is associated with mobile device 209 may have one or more pieces of software that automatically collect device data for mobile device 209. In embodiments, the collected device data may be sent automatically to issuer backend 220 as a result of the process initiated by the transaction request at step 230.

In some embodiments, issuer backend 220 may request user information from third party metrics 216 at step 255. This request may be triggered by receipt of transaction request of 230 and the subsequent merchant-based information shared at step 235. The user information request of step 255 may pertain specifically to user 205. The request may also pertain to merchant 215, and in some embodiments, may include both. Third party metrics 216 may include any third-party that provides or otherwise makes available data and statistics regarding potential fraud.

Third party metrics 216 may create and store relevant data including one or more fraud model scores pertaining to user 205, merchant 215, and/or both. This data may also include bot detection, phone ownership checks from third-party providers, confirmation of mobile device data, etc. At 260, the third-party metrics may be returned to issuer backend 220.

At step 265, issuer backend 220, may parse and/or integrate all of the relevant information. Issuer backend may follow one or more rules, decision trees, strategies, etc. for applying the integrated data that includes the merchant-based user information. As a result of this process, issuer backend 220 may reach a transaction decision based on application of the rules to the dataset. The transaction decision may allow or disallow the transaction request. This decision may be in conjunction with a card network's traditional authorization network and authorization process. This transaction decision may occur independently from the card network authorization process and in parallel to that process. Further, collection, parsing, integrating, any applying of the user information/data, as well as the transaction decision of step 265 may occur in real-time as the transaction request is pending. In some embodiments, this process does not add any time to the time required to complete a traditional transaction with smart card 208. In some embodiments, transaction decision 265 may override an authentication from the card authorization network.

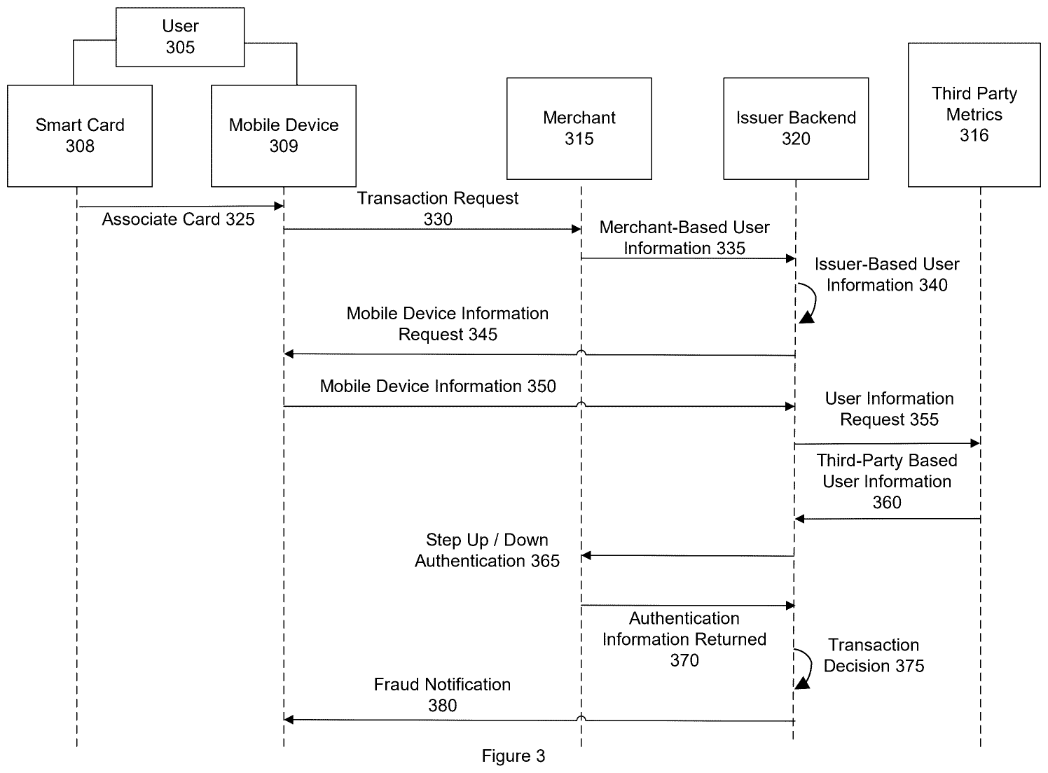

The sequence diagram of FIG. 3 illustrates an exemplary application of embodiments of the invention in conjunction with the system 100 of FIG. 1. In the scenario set forth in FIG. 3, a user 305 has a smart card 308 and a mobile device 309. The mobile device 309 is in communication with a merchant 315 and in some embodiments, an issuer backend 320. Mobile device 309 may be a personal computer, smart phone, smart watch, or any other network enabled computing device. Mobile device 309 may include memory, a network communication, an interactive user interface, and a processor capable of running one or more software applications and a digital wallet. Smart card 308 may be any chip enabled credit card or the like. Smart card 308 may be in communication with mobile device 309 via Bluetooth, NFC, or any other suitable short range communication protocol.

Issuer backend 320 may include one or more processors and may be in communication with mobile device 309, merchant 315, and third-party metrics 316. Backend 320 may be configured to transmit to and receive data from merchant 315 pertaining to a purchase transaction, and may be configured to transmit to and receive data from third party metrics 316.

Merchant 315 may include one or more processors and memory, as well as storage. It may be configured to run one or more websites, apps, etc. It may be further configured to provide a consumer facing sales interface that enables consumer purchase transactions of one or more goods or services on a website or app associated with merchant 315. It may be configured to communicate with backend 320 in order to transmit transaction requests as well as share consumer data.

Third party metrics 316 may include one or more processors and storage, such as a database or databases. It may be configured to receive data requests from issuer backend 320 and respond by providing data responsive to those requests.

User 305 may hold smart card 308 that may be associated with an issuer as well as one or more financial and/or credit accounts, etc. with that issuer. User 305 may also have a mobile device 309. At 325, user 305 may associate smart card 308 with mobile device 309 through any means available. By way of non-limiting example, this may be through inclusion of smart card 308 in a digital wallet of mobile device 309. It may also be through inclusion of smart card 308 with an application installed and running on mobile device 309. The application may be a shopping application or some other application that allows or facilitates payment of online purchases. Smart card 308 may be associated with mobile device 309 through any technological means, including but not limited to, manual entry, NFC, Bluetooth, etc. The association of smart card 308 may permit and/or enable mobile device 309 to collect and/or store information pertaining to user 305 as well as the user's account(s) associated with smart card 308.

At 330, mobile device 309 may transmit a transaction request to merchant 315. User 305 may shop for goods on mobile device 309. The shopping may be directly connected to merchant 315. For example, the shopping may take place on a website hosted by merchant 315 or an app developed and/or supported and/or hosted by merchant 315. Shopping on mobile device 309 may include adding one or more products to a virtual cart and then virtually checking out with those one or more products. The act of checking out with one or more products may result in mobile device 309 transmitting a transaction request to merchant 315 at step 330.

Merchant 315 may, as a result of receiving transaction request 330, provide merchant-based user information to issuer backend 320 at step 335. In order to provide the merchant-based user information, merchant 315 may collect data relevant to the transaction request. For example, merchant 315 may capture the specifics of the transaction request including number of products, price of products, highest priced item, descriptions of products, time of transaction request, name of user 305, shipping method, phone number, email address, address of user 305, shipping address of user 305, as well as any additional information provided by user 305 in connection with transaction request 330.

Merchant 315 may also include a memory, such as one or more databases, that stores data relevant to user 305. For instance, merchant 315 may store, and have access to, data pertaining to user 305's purchase history, including items and/or services purchased, dates of purchase, transaction amounts, transaction frequency, item purchase repetition, changes in user 305 purchase behavior, whether the transaction request involves a gift card, if the transaction request is a recurring order, age of any user account with merchant 315, velocity metrics (e.g. how often are transactions being requested by user 305 over a given period of time), merchant trust scores for user 305, etc.

Merchant 315 may also collect data from mobile device 309. This data may include one or more internet protocol (IP) addresses, geo-location, one or more unique ID's assigned to the device, etc.

Merchant 315 may package this information and send it to issuer backend 320 in real-time as the transaction request is pending. Historically, merchant 315 does not share any data pertaining to user 305 with an issuer except that data required to process a form of payment offered by user 305. Also historically, a user does not share the risk of fraudulent use of that user's card by a bad actor. The issuer generally alerts the user to the fraud, or the user detects the fraud and alerts the issuer, and then the issuer removes the fraudulent charge(s) from the user's account. The issuer does not bear the burden of loss from the fraudulent use of a user's card. Instead, the traditional approach dictates that the issuer passes that loss onto the merchant. Thus, while merchants have not historically shared user data with issuers, merchant 315 may be incentivized to do so, and to work collaboratively with the issuer if the issuer is willing to ultimately shift the burden of loss from merchant 315 to the issuer associated with issuer backend 320.

The merchant-based user information shared with issuer backend 320 at step 335 may be transmitted off network rails. For example, the merchant-based user information may be sent separate from a credit card network transmission. In some embodiments, the transmission of merchant-based user information may occur in parallel to traditional credit card network transmission seeking to authorize a transaction request.

At step 340, issuer backend 320 may collect issuer-based user information. This data may exist on one or more databases associated with the issuer and in connection with issuer backend 320. The issuer-based user information may include data that the issuer has been able to collect about user 305. For example, issuer-based user information may include user transaction history, not just with merchant 315, but for all purchases made by user 305 with smart card 308 or mobile device 309 (used as proxy for smart card 308 through a digital wallet or the like). This data may also include transaction history for one or more other different accounts held by user 305 with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that user 305 has never used smart card 308 at merchant 315 prior to transaction request 330. Or, this data could reveal that smart card 308 has only ever been used with a single merchant and that merchant is not 315. The information may further reveal that while user 305 has never used smart card 308 with merchant 315, that user has used a different card with merchant 315 on a regular basis. These are relevant pieces of information for issuer backend 320. Another example of relevant issuer-based user information might be a revelation that a large percentage of user purchases occur within a geographic space defined by some measurement. If transaction request 330 originates from a large distance away from that defined geographic location, then this fact could implicate potential fraud. However, if the user's most recent transaction history indicates that user 305 may have travelled to the location where transaction request 330 originates, then that information would mitigate against potential fraudulent activity.

At step 345, issuer backend 320 may request mobile device information from mobile device 309. At step 350, mobile device 309 may return the respond to the request. The response may include one or more pieces of mobile device data. This data may include one or more internet protocol (IP) addresses, geo-location, one or more unique ID's assigned to the device, etc. This information request may be instead of the merchant collecting and providing this information to issuer backend 320 at step 335. Alternatively, this request may be in addition to the device information sent at step 335 and may serve to confirm the device information.

In some embodiments, issuer backend 320 may request user information from third party metrics 316 at step 355. This request may be triggered by receipt of transaction request of 330 and the subsequent merchant-based information shared at step 335. The user information request of step 355 may pertain specifically to user 305. The request may also pertain to merchant 315, and in some embodiments, may include both. Third party metrics 316 may include any third-party that provides or otherwise makes available data and statistics regarding potential fraud.

Third party metrics 316 may create and store relevant data including one or more fraud model scores pertaining to user 305, merchant 315, and/or both. This data may also include bot detection, phone ownership checks from third-party providers, confirmation of mobile device data, etc. At 360, the third-party metrics may be returned to issuer backend 320.

Based on the data from the various sources, issuer backend 320 may make a fraud determination. Issuer backend 320, may parse and/or integrate all of the relevant information. Issuer backend may follow one or more rules, decision trees, strategies, etc. for applying the integrated data that includes the merchant-based user information. This determination may not be a simple yes/no decision, there may be finer gradations within the determination. For example, issuer backend 320 may determine some degree of elevated likelihood of fraud. Based on this determination, issuer backend 320 may not simply conclude the transaction is fraudulent and thereby refuse the transaction request. Instead, at step 365, based on determined levels of fraud likelihood, issuer backend 320 may step up (add friction) authentication requirements. These additional authentication requirements are sent to user 305 via merchant 315 and/or mobile device 309 at 365. Adding friction to the process is a way to increase comfort with an attempted transaction in the face of a given fraud risk determination.

If user 305 is presented with additional authentication verification requirements, then, based on responses to those stepped up requirements at step 370, issuer backend 320 may be able to determine a reduced likelihood of fraud. Or, in the alternative, if the responses to the stepped up authentication requirements are incomplete, insufficient, or otherwise wrong, issuer backend 320 may be able to confidently raise the fraud likelihood determination to a level where the transaction request is simply denied. The step up in authentication requirements may be varied and may be based on a given risk determination. For example, if the risk determination is minor, then the step up response may be relatively minor, such as email confirmation, texting a one-time code, or other quick forms of authentication. If the risk of fraud is more significant, then the step up may also be more significant. In this scenario, the step up may require multiple additional forms of authentication, biometrics, etc. In some cases, a phone call to user 305 may be required.

Just as the system may require stepped up authentication for instances where issuer backend 320 has determined a risk of fraud, there may be instances where issuer backend 320 may step down requirements. For example, if user 305 makes frequent purchases from merchant 315 and those purchases always include the same five items, then issuer backend 320 may be able to recognize these types of purchase patterns as non-fraudulent, and thereby increase the speed (e.g. reduce the friction) of the transaction approval process. One way in which the system may step down requirements is by dropping one or more cookies that will simplify and/or reduce friction for future purchases at the merchant 315 for user 305. The step down may create a situation when a transaction does not require any authentication by user 305. Other scenarios may be envisioned whereby issuer backend 320 determines a data pattern indicative of a legitimate transaction and, as a result, reduces friction on the transaction approval process.

At step 375, issuer backend 320 may integrate the stepped up authentication data with the existing data to reach an ultimate determination as to whether the transaction request should be approved. For example, as discussed above, if issuer backend 320 determined some moderate level of fraud risk, stepped up authentication requirement, and then received correct and fulsome responses to the step up, then the issuer backend 320 may determine that the fraud risk is low and the transaction request should be approved. If, instead, there is no response to the step up, then the issuer backend 320 may determine that the fraud risk is high and that the transaction request should be denied. There is also the potential for middle ground whereby the step up response is partially correct or otherwise incomplete. In this scenario, the issuer backend, may reject the transaction request, approve the transaction request, or delay while seeking more and/or different data to help inform the fraud risk. This additional data may be through addition of more friction.

The transaction decision at 375 may allow or disallow the transaction request. This decision may be made in conjunction with a card network's traditional authorization network and authorization process. This transaction decision may occur independently from the card network authorization process and in parallel to that process. Further, collection, parsing, integrating, any applying of the user information and/or data, as well as the transaction decision of step 375 may occur in real-time as the transaction request is pending. In some embodiment, this process does not add any time to the time required to complete a traditional transaction with smart card 308. In some embodiments, transaction decision 375 may override an authentication from the card authorization network. The transaction decision may be conveyed to merchant 315.

At 380, issuer backend 320 may send one or more notification to user 305. The notification may be sent to mobile device 309 and may entail a text, phone call, email, in-app message, or any other form of digital communication. The message may be tailored depending on the delivery medium. For instance, if issuer backend 320 sends a text message to mobile device 309, the text may simply tell user 305 that there was a suspected fraudulent charge associated with the account of smart card 308. The text may also include a phone number link that when clicked, initiates a call to the issuer. The text may also include a clickable link to other relevant pieces of information. For example, there may be links in the text to the user's account, transaction details for the suspected fraudulent transaction, location information, etc. In the event that the transaction request originates from a brick and mortar store for merchant 315 and that merchant has shared video surveillance data, the link may include video showing the attempted transaction. This may allow user 305 to recognize the person attempting the transaction. An email alert may include some, all, or none of the same links possible in the text message or in-app message options.

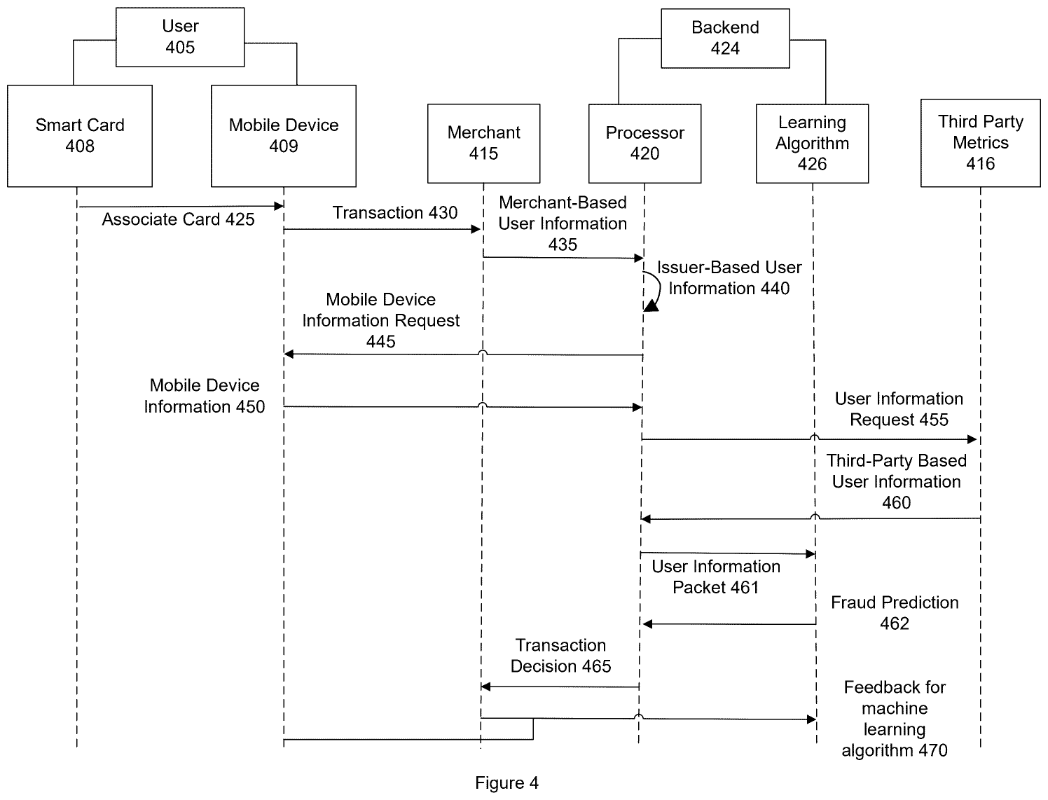

The sequence diagram of FIG. 4 illustrates an exemplary application of embodiments of the invention in conjunction with the system 100 of FIG. 1. In the scenario set forth in FIG. 4, a user 405 has a smart card 408 and a mobile device 409. The mobile device 409 is in communication with a merchant 415 and in some embodiments, a processor 420 of issuer backend 424. Mobile device 409 may be a personal computer, smart phone, smart watch, or any other network enabled computing device. Mobile device 409 may include memory, a network communication, an interactive user interface, and a processor capable of running one or more software applications and a digital wallet. Smart card 408 may be any chip enabled credit card or the like. Smart card 408 may be in communication with mobile device 409 via Bluetooth, NFC, or any other suitable short range communication protocol.

Issuer backend 424 may include one or more processors (e.g., processor 420) and may be in communication with mobile device 409, merchant 415, and third-party metrics 416. Processor 420 may be configured to transmit to and receive data from merchant 415 pertaining to a purchase transaction, and may be configured to transmit to and receive data from third party metrics 416.

Merchant 415 may include one or more processors and memory, as well as storage. It may be configured to run one or more websites, apps, etc. It may be further configured to provide a consumer facing sales interface that enables consumer purchase transactions of one or more goods or services on a website or app associated with merchant 415. It may be configured to communicate with backend 424 via processor 420 in order to transmit transaction requests as well as share consumer data.

Third party metrics 416 may include one or more processors and storage, such as a database or databases. It may be configured to receive data requests from processor 420 and respond by providing data responsive to those requests.

User 405 may hold smart card 408 that may be associated with an issuer as well as one or more financial and/or credit accounts, etc. with that issuer. User 405 may also have a mobile device 409. At step 425, user 405 may associate smart card 408 with mobile device 409 through any means available. By way of non-limiting example, this may be through inclusion of smart card 408 in a digital wallet of mobile device 409. It may also be through inclusion of smart card 408 with an application installed and running on mobile device 409. The application may be a shopping application or some other application that allows or facilitates payment of online purchases. Smart card 408 may be associated with mobile device 409 through any technological means, including but not limited to, manual entry, NFC, Bluetooth, etc. The association of smart card 408 may permit and/or enable mobile device 409 to collect and/or store information pertaining to user 405 as well as the user's account(s) associated with smart card 408.

At 430, mobile device 409 may transmit a transaction request to merchant 415. User 405 may shop for goods on mobile device 409. The shopping may be directly connected to merchant 415. For example, the shopping may take place on a website hosted by merchant 415 or an app developed and/or supported/hosted by merchant 415. Shopping on mobile device 409 may include adding one or more products to a virtual cart and then virtually checking out with those one or more products. The act of checking out with one or more products may result in mobile device 409 transmitting a transaction request to merchant 415 at step 430.

Merchant 415 may, as a result of receiving transaction request 430, provide merchant-based user information to processor 420 at step 435. In order to provide the merchant-based user information, merchant 415 may collect data relevant to the transaction request. For example, merchant 415 may capture the specifics of the transaction request including number of products, price of products, highest priced item, descriptions of products, time of transaction request, name of user 405, shipping method, phone number, email address, address of user 405, shipping address of user 405, as well as any additional information provided by user 405 in connection with transaction request 430.

Merchant 415 may also include a memory, such as one or more databases, that stores data relevant to user 405. For instance, merchant 415 may store, and have access to, data pertaining to user 405's purchase history, including items and/or services purchased, dates of purchase, transaction amounts, transaction frequency, item purchase repetition, changes in user 405 purchase behavior, whether the transaction request involves a gift card, if the transaction request is a recurring order, age of any user account with merchant 415, velocity metrics (e.g. how often are transactions being requested by user 405 over a given period of time), merchant trust scores for user 405, etc.

Merchant 415 may also collect data from mobile device 409. This data may include one or more internet protocol (IP) addresses, geo-location, one or more unique ID's assigned to the device, etc.

Merchant 415 may package this information and send it to processor 420 in real-time as the transaction request is pending. Historically, merchant 415 does not share any data pertaining to user 405 with an issuer except that data required to process a form of payment offered by user 405. Also historically, a user does not share the risk of fraudulent use of that user's card by a bad actor. The issuer generally alerts the user to the fraud, or the user detects the fraud and alerts the issuer, and then the issuer removes the fraudulent charge(s) from the user's account. The issuer does not bear the burden of loss from the fraudulent use of a user's card. Instead, the traditional approach dictates that the issuer passes that loss onto the merchant. Thus, while merchants have not historically shared user data with issuers, merchant 415 may be incentivized to do so, and to work collaboratively with the issuer if the issuer is willing to ultimately shift the burden of loss from merchant 415 to the issuer associated with processor 420.

The merchant-based user information shared with issuer backend 424 via processor 420 at step 435 may be transmitted off network rails. For example, the merchant-based user information may be sent separate from a credit card network transmission. In some embodiments, the transmission of merchant-based user information may occur in parallel to traditional credit card network transmission seeking to authorize a transaction request.

At step 440, processor 420 may collect issuer-based user information. This data may exist on one or more databases associated with the issuer backend 424. The issuer-based user information may include data that the issuer has been able to collect about user 405. For example, issuer-based user information may include user transaction history, not just with merchant 415, but for all purchases made by user 405 with smart card 408 or mobile device 409 (used as proxy for smart card 408 through a digital wallet or the like). This data may also include transaction history for one or more other different accounts held by user 405 with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that user 405 has never used smart card 408 at merchant 415 prior to transaction request 430. Or, this data could reveal that smart card 408 has only ever been used with a single merchant and that merchant is not 415. The information may further reveal that while user 405 has never used smart card 408 with merchant 415, that user has used a different card with merchant 415 on a regular basis. These are relevant pieces of information for processor 420. Another example of relevant issuer-based user information might be a revelation that a large percentage of user purchases occur within a geographic space defined by some measurement. If transaction request 430 originates from a large distance away from that defined geographic location, then this fact could implicate potential fraud. However, if the user's most recent transaction history indicates that user 405 may have travelled to the location where transaction request 430 originates, then that information would mitigate against potential fraudulent activity.

At step 445, processor 420 may request mobile device information from mobile device 409. At step 450, mobile device 409 may return the respond to the request. The response may include one or more pieces of mobile device data. This data may include one or more internet protocol (IP) addresses, geo-location, one or more unique ID's assigned to the device, etc. This information request may be instead of the merchant collecting and providing this information to processor 420 at step 435. Alternatively, this request may be in addition to the device information sent at step 435 and may serve to confirm the device information.

In some embodiments, processor 420 may request user information from third party metrics 416 at step 455. This request may be triggered by receipt of transaction request of 430 and the subsequent merchant-based information shared at step 435. The user information request of step 455 may pertain specifically to user 405. The request may also pertain to merchant 415, and in some embodiments, may include both. Third party metrics 416 may include any third-party that provides or otherwise makes available data and statistics regarding potential fraud.

Third party metrics 416 may create and store relevant data including one or more fraud model scores pertaining to user 405, merchant 415, and/or both. This data may also include bot detection, phone ownership checks from third-party providers, confirmation of mobile device data, etc. At step 460, the third-party metrics may be returned to processor 420.

At step 461, the data collected by processor 420 may be packaged and sent to learning algorithm 426 for analysis. Learning algorithm 426 may consider any and all of the data from merchant 415, issuer backend 424, as well as third party metrics 416. In making a likelihood of fraud determination, learning algorithm 426 may consider the data in relation to the transaction request (e.g., the potential loss given the requested transaction amount), the amount of data, the relevance of the data, relationships between metrics, between metrics and the transaction request, etc. The learning algorithm 426 may weight each metric/data point and make predictions based on a complex analysis of all metrics, relative deviation(s) in each metric, connections between metrics as determined by deep learning aspects of learning algorithm 426, summing or subtracting deviations based on relationships with other metrics, increasing or decreasing relative weights based on established relationships between and among metrics, etc. The machine learning algorithm 426 may also adjust weighting and relationships based on feedback from previous fraud predictions. Learning algorithm 426 may be able to test detected relationships and analyses based on these relationships through feedback on predictions over time. In some embodiments, there may be a hybrid approach where some number of baseline rules are programmed and then learning algorithm 426 operates and makes predictions on top of that baseline set of rules. The baseline set of rules may include boundary rules when the machine learning algorithm 426 must, or must not, conclude the existence of fraud.

Learning algorithm 426 may be an open Al system. This requirement may be necessary so that the reason and logic behind fraud predictions is known and understood. This information may be necessary to correct any potential deviations learning algorithm may attempt to make based on irrelevant details or details that may otherwise not be allowed under law. Moreover, the reasons for a fraud prediction may be necessary to form the basis for feedback into the learning algorithm and/or to otherwise provide notice to user 405. For instance, the transaction request of step 430 may be refused based on a fraud prediction from learning algorithm 426. In such an instance, the refusal prevented commerce while maybe preventing actual fraud. There must be a way to determine whether such refusals are accurate or if they are overinclusive false positives. Determining the accuracy of a prediction in this context may be greatly aided by an understanding of the basis for the outcome/prediction.

To the extent that a prediction may be simplified to one or more primary factors (as opposed to a complex interaction of factors), it is also important to be able to provide that information to user 405. For instance, if a transaction is refused and a message sent to user 405, it would be beneficial to say in that message that not only was there a suspected fraudulent transaction, but that the transaction was suspected fraudulent because it originated from a different country and was attempted with a merchant 415 that user 405 has never purchased from in the past. This provides user 405 with the basis for the transaction refusal which, if legitimate, provides user 405 with the information required to resolve the problem with the issuer. For example, if a phone number link is provided in the communication message with user 405, that user may contact the issuer and then alert the issuer that he or she is travelling in the country where the transaction originated and is indeed trying to make a purchase at merchant 415. Not only does this facilitate commerce, it also provides critical feedback for learning algorithm 426.

The fraud prediction may not be a simple yes/no prediction, instead, there may be finer gradations within the predictions. For example, learning algorithm 426 may determine some degree of elevated likelihood of fraud. In some embodiments, the fraud prediction may be a score on a predetermined scale. When learning algorithm 426 provides the fraud prediction to processor 420 at step 462, processor 420 may further process the prediction to reach a transaction decision. The transaction decision may be based on a likelihood of fraud predicted by learning algorithm 426 and may be transmitted to merchant 415 and user 405. The transaction decision may allow or disallow the transaction request. This decision may be in conjunction with a card network's traditional authorization network and authorization process. This transaction decision may occur independently from the card network authorization process and in parallel to that process. Further, the transaction decision of step 465 may occur in real-time as the transaction request is pending. In some embodiment, this process does not add any time to the time required to complete a traditional transaction with smart card 408. In some embodiments, transaction decision 465 may override an authentication from the card authorization network.

If a transaction is denied at 465, processor 420 may send one or more notification to user 405. The notification may be sent to mobile device 409 and may entail a text, phone call, email, in-app message, or any other form of digital communication. The message may be tailored depending on the delivery medium. For instance, if processor 420 sends a text message to mobile device 409, the text may simply tell user 405 that there was a suspected fraudulent charge associated with the account of smart card 408. The text may also include a phone number link that when clicked, initiates a call to the issuer. The text may also include a clickable link to other relevant pieces of information. For example, there may be links in the text to the user's account, transaction details for the suspected fraudulent transaction, location information, etc. In the event that the transaction request originates from a brick and mortar store for merchant 415 and that merchant has shared video surveillance data, the link may include video showing the attempted transaction. This may allow user 405 to recognize the person attempting the transaction. An email alert may include some, all, or none of the same links possible in the text message or in-app message options.

Triggering a response from user 405 is one form of feedback for learning algorithm 426 at step 470. Additionally, feedback may come from merchant 415. The feedback is provided to learning algorithm 426 to train, further refine, and improve learning algorithm 426. The user feedback data may help train the machine learning algorithm in a variety of different ways. For example, if the user feedback is indicates an incorrect prediction, for example, a user response explaining the transaction is legitimate and providing information as to why, then the learning algorithm 426 will be able to refine the predictions and change and/or optimize weighting and relationships that led to the incorrect prediction. The same may be true for feedback indicating that learning algorithm 426 correctly predicted fraud. This feedback may be useful to more positively reinforce correct predictions, or to make refinements in the case where learning algorithm 426 may have made the correct prediction, but for faulty reasons. This may include changing weighting for factors that more strongly favor the correct analysis, etc. The foregoing are examples of how the user feedback data may be used by the learning algorithm 426 and are not meant to be exhaustive.

With continued feedback and training of the learning algorithm 426 over time, the learning algorithm 426 may not only become more accurate, but also more efficient. This is because less computing resources are required as the machine learning algorithm becomes more confident in its predictions. Thus, not only is the accuracy of the predictions improved over time, but the functioning of the computer is also improved over time as the learning algorithm 426 is trained.

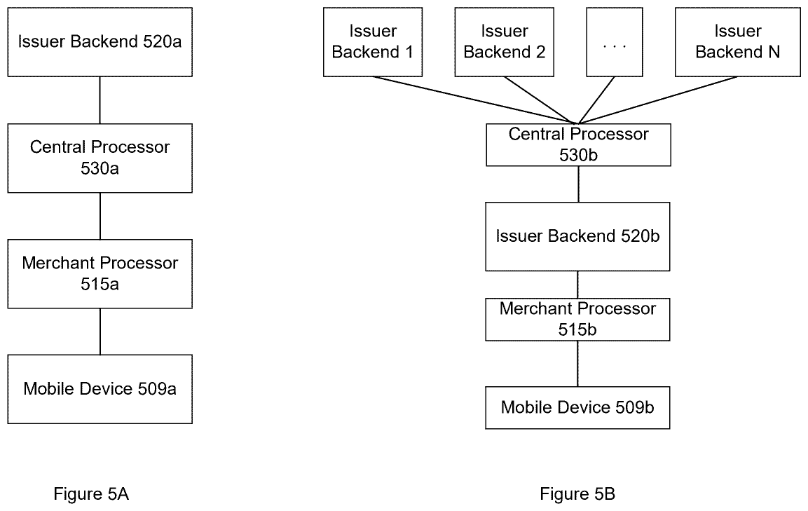

FIG. 5A describes an embodiment of exemplary systems. In FIG. 5A, a central processor 530a is connected to an issuer backend 520a. An issuer backend can include a processor or server associated with a provider of personal financing, including without limitation checking accounts, savings accounts, credit accounts, or some combination thereof. For example, an issuer backend can include the credit card provider associated with a user's credit card. The central processor 530a can also be connected to a merchant processor 515a and a user device 509a over a network.

In this embodiment, the process is similar to that described in FIG. 2 except that central processor 530a sits between merchant processor 515a and issuer backend 520a. Mobile device 509a belonging to a user may still be used to initiate a transaction request with merchant processor 515a. In turn, merchant processor may collect user data including data relevant to both the transaction request as well as historical user data available to merchant processor 515a. Instead of sharing this merchant-based user data directly with issuer backend 520a, it is shared with central processor 530a. Central processor then makes the merchant-based user information available to issuer backend 520a. The central processor may store the merchant-based user information and serve as a storage and clearinghouse for merchant-based user information.

In some embodiments, central processor 530a may make an initial determination as to the potential for fraud. For example, if there are one or more obvious fraud indicators, central processor 530a may predict fraud and deny the transaction immediately. In other embodiments, central processor 530a may be equipped to perform the fraud predictions made by the issuer backend described with respect to FIGS. 2-4

In some embodiments, multiple issuer backends may connect to central processor 530a as well as multiple merchants. Central processor 530a may be able to not only store the data from various merchants, it may be able to direct the data to the correct issuer backend. Also, central processor 530a may be able to access and share relevant merchant-based user information across transaction requests and/or with different issuer backends. For example, if a user initiates a transaction request with merchant processor 515a via mobile device 509a, then central processor 530a may not only provide the merchant-based user information with issuer backend 520a, but may also search its own storage and find merchant-based user data from other merchants relating to the same user and/or mobile device 509a. Central processor 530a may send this additional information to issuer backend 520a. Similarly, in future transaction requests, the merchant-based user data that was created by merchant processor 515a in the example above may be used by central processor 530a to supplement the information share relating to the future transaction request either with issuer backend 520a or with a different issuer backend.

Not only is central processor 530a capable of increasing the relevant data shared with issuer backend 520a (as well as with other issuer backends), it may also be capable of receiving issuer-based user information from issuer backend 520a. Central processor 530a may be capable of storing this data and further supplementing relevant data share with any of the communicating issuer backends. For example, issuer backend 520a may provide to central processor 530a, issuer-based user data pertaining to a user associated with a transaction request. Central processor 530a may store that issuer-based user information. In a subsequent transaction request involving a different issuer backend, central processor 530a may include the stored issuer-based user information with the merchant-based user information that it sends to that different issuer backend. Thus, the different issuer backend has more historical user transaction data than it otherwise would have, and can make a more informed decision/prediction regarding the likelihood that the pending transaction request is fraudulent. Thus, the central processor 530a may form the hub in an information sharing architecture where each issuer backend, and each merchant, creates a spoke off of the hub.

In some embodiments, the sharing of issuer data between issuers may not happen automatically or be dictated by the central processor 530a. In some embodiments, an issuer may request supplemental issuer backend from other issuers as part of creating a fraud prediction. The request may be sent to the central processor 530a and routed to one or more of the participating issuers. The issuers may then respond to the request through the central processor 530a. There may be a time aspect to such an approach. Because the fraud transaction usually needs to occur in real-time, in conjunction with the attempted transaction, there may be a limit on how long an issuer may be able to wait for responses from other issuers. In some embodiments, a user may be asked to wait some additional amount of time in order to complete the transfer of information and to complete a fraud prediction. A request for more time may be based on a delayed response from one or more issuer and/or one or more preliminary indicators that may suggest the existence of a fraudulent transaction.

In the embodiment illustrated in FIG. 5B, the architecture of the hub and spoke system is slightly different. Here, a transaction request may be received by merchant processor 515b from a user via mobile device 509b. As a result, the merchant processor 515b may directly share merchant-based user information with issuer backend 520b, similar to FIG. 2. In turn, issuer backend 520b may send the merchant-based user information, as well as the issuer-based user information to central processor 530b. Central processor 530b may be connected to any number of issuer backends 1 through N.

The central processor 530b may store the issuer-based user information as well as the merchant-based user information shared by issuer backend 520b. Central processor 530b may serve as a storage and clearinghouse for issuer-based user information and merchant-based user information. Central processor 530b may be able to access and share relevant merchant-based user information across transaction requests and/or with different issuer backends. For example, if a user initiates a transaction request with merchant processor 515b via mobile device 509b, then central processor 530b, upon issuer backend 520b sharing relevant data with central processor 530b, may search its own storage and find merchant-based user data from other merchants relating to the same user and/or mobile device 509b. Central processor 530b may return this additional information to issuer backend 520b. Similarly, in future transaction requests, the merchant-based user data that was created by merchant processor 515b in the example above may be used by central processor 530b to supplement the information share relating to the future transaction request either with issuer backend 520b or with a different issuer backend, such as issuer backend 1 through N. The same is true for sharing issuer-based user data among the various issuer backends. Central processor 530a may be capable of storing this issuer-based user data and further supplementing relevant data share with any of the communicating issuer backends. For example, issuer backend 520b may provide to central processor 530b, issuer-based user data pertaining to a user associated with a transaction request. Central processor 530a may store that issuer-based user information. In a subsequent transaction request involving a different issuer backend, central processor 530b may include the stored issuer-based user information with the merchant-based user information that it sends to that different issuer backend (1 through N). Thus, the different issuer backend has more historical user transaction data than it otherwise would have, and can make a more informed decision/prediction regarding the likelihood that the pending transaction request is fraudulent. Thus, the central processor 530b may form the hub in an information sharing architecture where each issuer backend creates a spoke off of the hub.

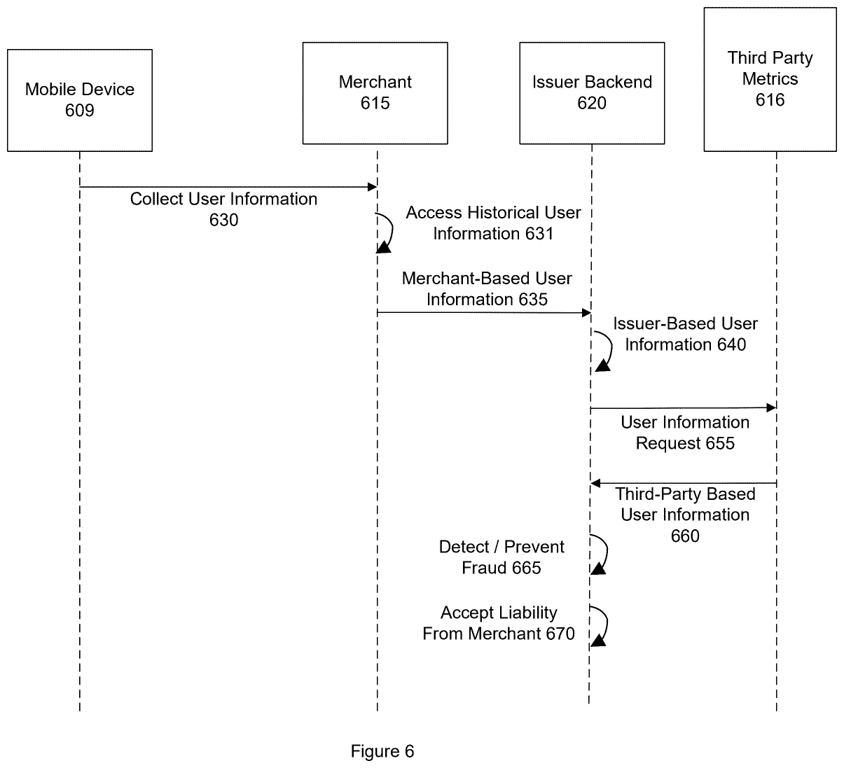

The sequence diagram of FIG. 6 illustrates an exemplary application of embodiments of the invention in conjunction with the system 100 of FIG. 1. In the scenario set forth in FIG. 6, a mobile device 609 is in communication with a merchant 615 and in some embodiments, an issuer backend 620. Mobile device 609 may be a personal computer, smart phone, smart watch, or any other network enabled computing device. Mobile device 609 may include memory, a network communication, an interactive user interface, and a processor capable of running one or more software applications and a digital wallet.

Issuer backend 620 may include one or more processors and may be in communication with mobile device 609, merchant 615, and third-party metrics 616. Backend 620 may be configured to transmit to and receive data from merchant 615 pertaining to a purchase transaction, and may be configured to transmit to and receive data from third party metrics 616.

Merchant 615 may include one or more processors and memory, as well as storage. It may be configured to run one or more websites, apps, etc. It may be further configured to provide a consumer facing sales interface that enables consumer purchase transactions of one or more goods or services on a website or app associated with merchant 615. It may be configured to communicate with backend 620 in order to share user and/or consumer data.

Third party metrics 616 may include one or more processors and storage, such as a database or databases. It may be configured to receive data requests from issuer backend 620 and respond by providing user metrics data responsive to those requests.

At 630, merchant 615 may collect relevant user-based data from mobile device 609. The user-based data may include a transaction request with relevant transaction request details. For example, on owner of mobile device 609 may shop for goods on mobile device 609. The shopping may be directly connected to merchant 615. For example, the shopping may take place on a website hosted by merchant 615 or an app developed and/or supported or hosted by merchant 615. Shopping on mobile device 609 may include adding one or more products to a virtual cart and then virtually checking out with those one or more products. The act of checking out with one or more products may result in mobile device 609 transmitting transaction request details to merchant 615 at step 630. These transaction details may include the specifics of the transaction request including number of products, price of products, highest priced item, descriptions of products, time of transaction request, name of user, shipping method, phone number, email address, address of user, shipping address of user, as well as any additional information provided by user in connection with the transaction request.

In addition to transaction request details, merchant 615 may also include a memory, such as one or more databases, that stores historical user-based data. Merchant 615 may access that historical user-based data at step 631. Merchant 615 may store, and have access to, data pertaining to a user's purchase history, including items and/or services purchased, dates of purchase, transaction amounts, transaction frequency, item purchase repetition, changes in user purchase behavior, whether the transaction request involves a gift card, if the transaction request is a recurring order, age of any user account with merchant 615, velocity metrics (e.g. how often are transactions being requested by user 205 over a given period of time), merchant trust scores for the user, etc. Merchant 615 may also collect data from mobile device 609. This data may include one or more internet protocol (IP) addresses, geo-location, one or more unique ID's assigned to the device, etc.

Merchant 615 may package this information and send it to issuer backend 620 in real-time as the transaction request is pending at step 635. Historically, a merchant does not share any data pertaining to a user with an issuer except the data required to process a form of payment offered by a user. Also historically, a user does not share the risk of fraudulent use of that user's card by a bad actor. The issuer generally alerts the user to the fraud, or the user detects the fraud and alerts the issuer, and then the issuer removes the fraudulent charge(s) from the user's account. Further, the issuer does not bear the burden of loss from the fraudulent use of a user's card. Instead, the traditional approach dictates that the issuer passes that loss onto the merchant. Thus, while merchants have not historically shared user data with issuers, merchant 615 may be incentivized to do so, and to work collaboratively with the issuer if the issuer is willing to ultimately shift the burden of loss from merchant 615 to the issuer associated with issuer backend 620.

The merchant-based user information shared with issuer backend 620 at step 235 may be transmitted off network rails. For example, the merchant-based user information may be sent separate from a credit card network transmission. In some embodiments, the transmission of merchant-based user information may occur in parallel to traditional credit card network transmission seeking to authorize a transaction request.

At step 640, issuer backend 620 may collect issuer-based user information. This data may exist on one or more databases associated with the issuer and in connection with issuer backend 620. The issuer-based user information may include data that the issuer has been able to collect about the relevant user. For example, issuer-based user information may include user transaction history, not just with merchant 615, but for all purchases made by the user on a specific issuer account. This data may also include transaction history for one or more additional different accounts held by the user with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that the user has never used a specific issuer account at merchant 615 prior to a given transaction request. Or, this data could reveal that the issuer account has only ever been used with a single merchant and that merchant is not 615. The information may further reveal that while the user has never used the issuer account with merchant 615, that user has used a different issuer account with merchant 615 on a regular basis. These are relevant pieces of information for issuer backend 620. Another example of relevant issuer-based user information might be a revelation that a large percentage of user purchases occur within a geographic space defined by some measurement. If a transaction request originates from a long distance away from that defined geographic location, then this fact could implicate potential fraud. However, if the user's most recent transaction history indicates that the user may have travelled to the location where the transaction request originated, then that information would mitigate against potential fraudulent activity.

In some embodiments, issuer backend 620 may request user information from third party metrics 616 at step 655. This request may be triggered by a specific transaction request and the subsequent merchant-based information shared at step 635. The user information request of step 655 may pertain specifically to a user associated with the transaction request. The request at 655 may also pertain to merchant 615, and in some embodiments, may pertain to both the merchant 615 and the relevant user. Third party metrics 616 may include any third-party that provides or otherwise makes available data and statistics regarding potential fraud.

Third party metrics 616 may create and store relevant data including one or more fraud model scores pertaining to the user, merchant 615, and/or both. This data may also include bot detection, phone ownership checks from third-party providers, confirmation of mobile device data, etc. At 660, the third-party metrics may be returned to issuer backend 620.

At step 665, issuer backend 620, may detect and/or prevent fraud. This process may follow the steps laid out with respect to 265 of FIG. 2, 365-375 of FIG. 3, and/or 461-465 of FIG. 4. Once issuer backend 660 has detected and/or prevented fraud in enough instances, the fraud rate for a given merchant, in this example merchant 615, will decrease. As noted above, merchant 615 is incentivized to share user-based data with an issuer of issuer backend 620 on the basis that there could be a liability shift for fraudulent transactions, from the merchant to the issuer. The overarching goal is to reduce fraudulent transactions, and it may be that the issuer is comfortable accepting the risk of loss from fraudulent transactions on a merchant-by-merchant basis if the merchant is willing to share enough user-based data so that the issuer may develop a robust system capable of decreasing instances of fraud below a threshold level. It may be that the issuer has negotiated metrics that, once met, will result in liability shift from the merchant to the issuer, such as a fraud threshold level. At step 670, as a result of ongoing fraud prevention at step 665, and similar iterations of the steps of FIG. 6 for a given merchant (e.g., merchant 615), fraud at merchant 615 drops below a threshold level and an issuer associated with issuer backend 620 shifts the risk of fraudulent transactions from merchant to the issuer. This liability shift may be conditioned on merchant 615 not only providing robust user-based data, but also positive results stemming from the sharing of user-based data.

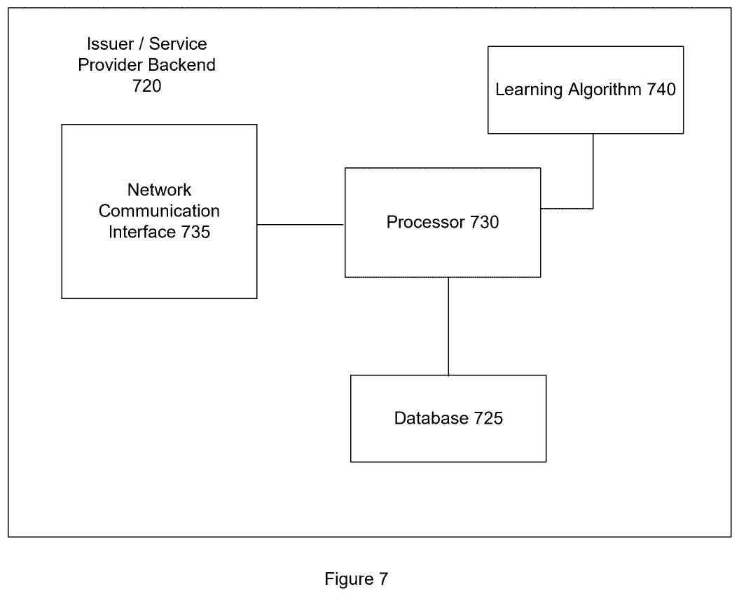

With reference to FIG. 7, issuer backend 720 may be a server such as a dedicated server computer, such as bladed servers, or personal computer, laptop computer, notebook computer, palm top computer, network computer, or any processor-controlled device capable of supporting the system 100. While FIG. 7 illustrates a issuer backend 720 that may be a single server, it is understood that other embodiments can use multiple servers or multiple computer systems as necessary or desired to support the users and can also use back-up or redundant servers to prevent network downtime in the event of a failure of a particular server. In a particular embodiment illustrated in FIG. 7, issuer backend 720 includes a processor 730 in communication with a database 725, a network communication interface 735, and a learning algorithm 740. The processor 730 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The database 725 may comprise memory and can be a read-only memory, write-once read-multiple memory or read/write memory, e.g., RAM, ROM and EEPROM, and the user device can include one or more of these memories.

The network communication interface 735 is configured to establish and support wired and/or wireless data communication capability for connecting the issuer backend 720 to the network 110 or other communication network. The network communication interface 735 can also be configured to support communication with a short-range wireless communication interface, such as Bluetooth.

In embodiments of the invention, the processor 730 may be in communication, through network communication interface 735, with a merchant in order to monitor and collect user-based merchant data, triggered by user transaction requests. Processor 730 may also be in communication, through network communication interface 735, with a third-party metrics aggregator in order to request/receive third-party user data. Processor 730 may store this user-based data in database 725. Additionally, processor 730 may access issuer-based user data from database 725. Processor 730 may send this user-based data, as well as transaction request details to machine learning algorithm 740 for use in predicting fraud in connection with the transaction request. Machine learning algorithm 740 may use the provided data/information, as well as additional inputs to predict a likelihood that the transaction request is fraudulent. Processor 730 may receive the fraud prediction and incorporate it into a transaction decision that it may pass on to the merchant. Alternatively, processor 730 may change the transaction friction (either up or down) based on the fraud prediction provided by learning algorithm 740.

The transaction decision may allow or disallow the transaction request. This decision may be in conjunction with a card network's traditional authorization network and authorization process. This transaction decision may occur independently from the card network authorization process and in parallel to that process. Further, the transaction decision may occur in real-time as the transaction request is pending. In some embodiments, this process does not add any time to the time required to complete a traditional card-based transaction. In some embodiments, the transaction decision may override an authentication from the card authorization network.

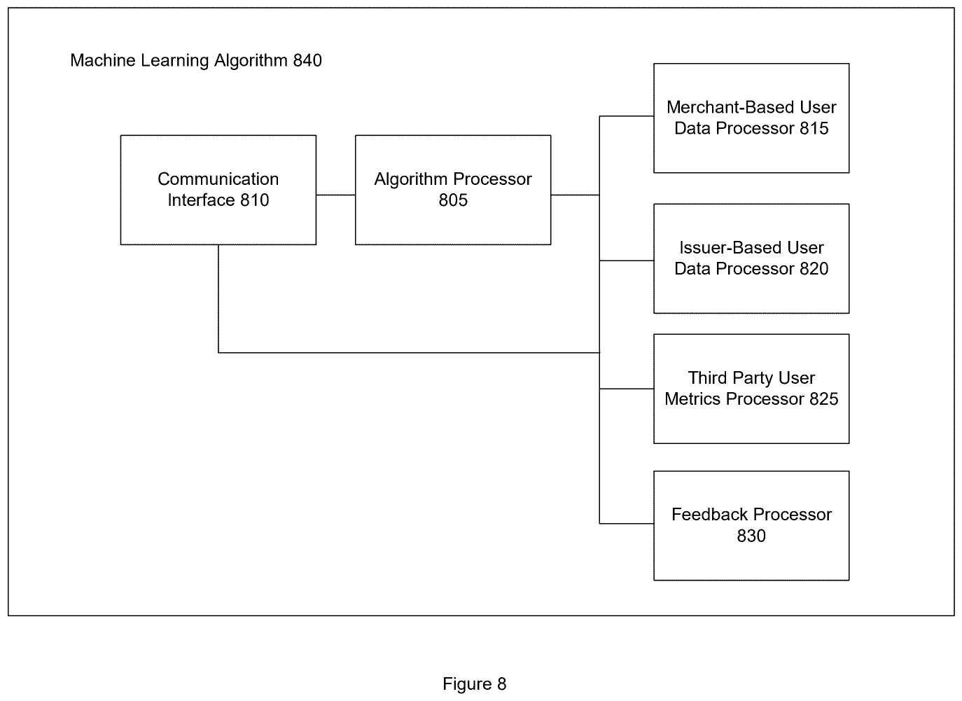

With reference to FIG. 8, machine learning algorithm 840 may be part of an application backend and may predict the likelihood that a transaction request is fraudulent. Machine learning algorithm 840 may be “open” so that services providers and/or issuers can see the logic behind fraud predictions. The reasoning or logic behind predictions made by machine learning algorithm 840 may be important so that these reasons may be conveyed in some instances to users for feedback, stepped up authentication, etc. In other instances, the logic applied by machine learning algorithm 840 may need to be specifically altered if it is a criteria deemed irrelevant, unlawful, etc. by a service provider or issuer. Machine learning algorithm 840 may include a communication interface 810 as well as an algorithm processor 805 coupled to a plurality of additional processors including merchant-based user data processor 815, issuer-based user data processor 820, third party metrics processor 825, and feedback processor 830. The processors of FIG. 8 may include microprocessors and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. It should be appreciated that while FIG. 8 depicts multiple discrete processors, the machine learning algorithm may be accomplished by any number of processors including a single processor.

Machine learning algorithm 840 may receive a number of inputs from the issuer backend through communication interface 810. These inputs may include merchant-based user data, which may include data relevant to the transaction request. For example, a merchant may capture the specifics of the transaction request including number of products, price of products, total transaction cost, highest priced item, descriptions of products, time of transaction request, name of the user requesting the transaction, requested shipping method, user phone number, user email address, user address, a shipping address, as well as any additional information provided by a user in connection with a transaction request. A merchant may also provide relevant historical user data vis-à-vis the merchant. For instance, a merchant may store, and have access to, data pertaining to a user's purchase history with the merchant, including items and/or services purchased, dates of purchase, transaction amounts, transaction frequency, item purchase repetition, changes in user purchase behavior, whether the transaction request involves a gift card, if the transaction request is a recurring order, age of any user account with the merchant, velocity metrics (e.g. how often are transactions being requested by user over a given period of time), merchant trust scores for the user, etc. A merchant may also collect and then share data from a user's mobile device. This data may include one or more internet protocol (IP) addresses, geo-location, one or more unique ID's assigned to the device, etc. This merchant-based user data may be provided as an input to merchant-based user data processor 815.

Another machine learning algorithm 840 input may include issuer-based user data. This data may include information that the issuer has been able to collect about a user over time. For example, issuer-based user information may include user transaction history, not just with a specific merchant, but for all purchases made by the user with a smart card or mobile device linked to an account for the issuer. This data may also include transaction history for one or more other different accounts held by the user with the issuer. The data may not include visibility as to specific items that were purchased, individual pricing of items, etc., but this data may provide transaction amounts including largest transactions over a given time frame, largest transactions at each discrete merchant, merchant transaction frequency, dates, velocity metrics, purchase patterns, purchase locations, etc. For example, issuer-based user information may highlight that a user has never used a given smart card at a specific merchant prior to a pending transaction request. Or, this data could reveal that the smart card has only ever been used with a single merchant and that merchant is not the merchant in the pending transaction request. The information may further reveal that while the user has never used the smart card with the merchant in the pending transaction request, that user has used a different card/account with the merchant on a regular basis. These are relevant pieces of information for the issuer-based user data processor 820. Another example of relevant issuer-based user information might be a revelation that a large percentage of a user's purchases occur within a geographic space defined by some measurement. If a transaction request originates from a long distance away from that defined geographic location, then this fact could implicate potential fraud. However, if the user's most recent transaction history indicates that the user may have travelled to the location where transaction request originated, then that information would mitigate against potential fraudulent activity.

Machine learning algorithm 840 may also receive third-party user-based metrics. Third party user-based metrics may include data relating to one or more fraud model scores pertaining to a user, merchant 215, and/or both. This data may also include online bot detection (based on navigation speed, navigation patterns, skipping interfaces, failure to satisfy bot detection protocols, etc.), phone ownership checks from third-party providers, confirmation of mobile device data, etc.

Additionally, machine learning algorithm 840 may receive feedback as a discrete type of input. The feedback may include feedback from a merchant and/or a user relating to one or more transaction decisions (e.g., refuse transaction request) as well as user notifications and explanations thereof. The accuracy of a machine learning algorithm 840 prediction may be inferred from the feedback and updated/edited accordingly.

Learning algorithm 840 may consider any and all of the inputs from processors 815, 820, 825, and 830, as well as the data input into those processors. In making a likelihood of fraud prediction, learning algorithm 840 may consider the data in relation to the transaction request (e.g., the potential loss given the requested transaction amount), the amount of data, the relevance of the data, relationships between metrics, between metrics and the transaction request, etc. The learning algorithm 840 may weight each metric/data point and make predictions based on a complex analysis of all metrics, relative deviation(s) in each metric, connections between metrics as determined by deep learning aspects of learning algorithm 840, summing or subtracting deviations based on relationships with other metrics, increasing or decreasing relative weights based on established relationships between and among metrics, etc. The machine learning algorithm 840 may also adjust weighting and relationships based on feedback from previous fraud predictions. Learning algorithm 840 may be able to test detected relationships and analyses based on these relationships through feedback on predictions over time. In some embodiments, there may be a hybrid approach where some number of baseline rules are programmed and then learning algorithm 840 operates and makes predictions on top of that baseline set of rules. The baseline set of rules may include boundary rules when the machine learning algorithm 426 must, or must not, conclude the existence of fraud.

Learning algorithm 840 may be an open Al system. This requirement may be necessary so that the reason and logic behind fraud predictions is known and understood. This information may be necessary to correct any potential deviations learning algorithm may attempt to make based on irrelevant details or details that may otherwise not be allowed under law. Moreover, the reasons for a fraud prediction may be necessary to form the basis for feedback into the learning algorithm and/or to otherwise provide notice to a user. For instance, a transaction request may be refused based on a fraud prediction from learning algorithm 840. In such an instance, the refusal prevented commerce while potentially preventing actual fraud. There may be a way to determine whether such refusals are accurate or if they are over-inclusive, false positives. Determining the accuracy of a prediction in this context may be greatly aided by an understanding of the basis for the outcome/prediction. To the extent that a prediction may be simplified to one or more primary factors (as opposed to a complex interaction of factors), it is also important to be able to provide that information to the user. For instance, if a transaction is refused and a message sent to the user, it would be beneficial to include in that message that not only was there a suspected fraudulent transaction, but that the transaction was suspected fraudulent because it originated from a different country and was attempted with a merchant that the user has never purchased from in the past. This provides the user with the basis for the transaction refusal which, if legitimate, further provides the user with the information required to resolve the problem with the issuer. For example, if a phone number link is provided in a communication message with the user, that user may contact the issuer and then alert the issuer that he or she is travelling in the country where the transaction originated and is indeed trying to make a purchase at the merchant. Not only does this facilitate commerce, it also provides critical feedback for learning algorithm 840 at feedback processor 830. Moreover, the fraud prediction may not be a simple yes/no prediction, instead, there may be finer gradations within the predictions. For example, learning algorithm 840 may determine some degree of elevated likelihood of fraud. The granularity of potential fraud in a prediction may be as fine as necessary to maximize the accuracy of the system and may become more granular as the system improves with feedback over time.

Feedback processor 830 may help refine future predictions by further analyzing the correct and incorrect prediction feedback. It may be the case that the prediction was correct but based on faulty reasoning/logic. In that case, the feedback is useful to train the learning algorithm by changing assumptions, weighting, revisiting perceived relationships, etc. In the event that the algorithm predicted correctly, and the prediction was based on a correct analysis, the feedback processor 830 may use the feedback to further reinforce the correct analysis. This may include changing weighting for factors that more strongly favor the correct analysis, etc.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The predictive models described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real-valued weight. Nodes may either be (i) input nodes (e.g., receiving data from outside the network), (ii) output nodes (e.g., yielding results), or (iii) hidden nodes (e.g., that may modify the data en route from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

It is noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, e.g., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A method for collaborative fraud prevention, the method comprising the steps of:
receiving, by a processor, merchant data pertaining to a user;
receiving, by the processor, issuer data pertaining to the user;
receiving, by the processor, third party metrics data pertaining to the user;
receiving, by the processor, mobile device data for a mobile device associated with the user;
applying, by the processor, a machine learning model to the merchant data, issuer data, third-party metrics, and mobile device data to make a fraud prediction;
receiving, by the processor, feedback on the fraud prediction; and
updating, by the processor, the machine learning model using the feedback as an input.

2. The method of claim 1, wherein the merchant data is based on a transaction request initiated by the user.

3. The method of claim 1, wherein the merchant data includes the mobile device data.

4. The method of claim 1, wherein the processor sends a request for one or both of the mobile device data and the third party metrics data.

5. The method of claim 2, wherein the transaction request is approved or denied based on the fraud prediction.

6. The method of claim 2, wherein a user authentication requirement is stepped up based on the fraud prediction.

7. The method of claim 1, further comprising, sending, via the processor, a fraud notification to the mobile device associated with the user.

8. The method of claim 1, wherein upon fraud at a merchant reaching a threshold level, an issuer associated with the processor accepts liability for fraudulent transactions at the merchant.

9. The method of claim 1, further comprising, receiving, via a communication hub, supplemental user data from a plurality of issuers.

10. The method of claim 9, further comprising, sending, via the processor, the fraud prediction to the communication hub.

11. A system for collaborative fraud prevention, the system comprising:
a memory storing issuer data for a user; and
a processor configured to:
receive merchant data pertaining to a user;
receive the issuer data for the user;
receive third party metrics data pertaining to the user;
receive mobile device data for a mobile device associated with the user;
apply a machine learning model to the merchant data, issuer data, third-party metrics, and mobile device data to make a fraud prediction;
receive feedback on the fraud prediction; and
update the machine learning model using the feedback as an input.

12. The system of claim 11, wherein the mobile device data comprises a plurality of an internet protocol address, a geo-location, and a unique device identifier (ID).

13. The system of claim 11, wherein the merchant data comprises a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

14. The system of claim 11, wherein the merchant data comprises a plurality of a user name, a user phone number, a user email address, a user physical address, a list of historical merchant transactions, a frequency of merchant purchases, an account age for a merchant account associated with the user, a total number of items, recurring order information, shipping information, and a merchant risk score.

15. The system of claim 11, wherein the merchant data is based on a transaction request initiated by the user.

16. The system of claim 11, wherein the merchant data includes the mobile device data.

17. The system of claim 15, wherein the transaction request is approved or denied based on the fraud prediction.

18. The system of claim 15, wherein a user authentication requirement is stepped up based on the fraud prediction.

19. The system of claim 11, wherein upon fraud at a merchant reaching a threshold level, an issuer associated with the processor accepts liability for fraudulent transactions at the merchant.

20. A computer-readable non-transitory medium comprising computer-executable instructions that, when executed by at least one processor, perform procedures comprising the steps of:
receiving, by a processor, merchant data pertaining to a user;
receiving, by the processor, issuer data pertaining to the user;
receiving, by the processor, third party metrics data pertaining to the user;
receiving, by the processor, mobile device data for a mobile device associated with the user;
applying, by the processor, a machine learning model to the merchant data, issuer data, third-party metrics, and mobile device data to make a fraud prediction;
receiving, by the processor, feedback on the fraud prediction; and
updating, by the processor, the machine learning model using the feedback as an input.
